(19) United States
(12) Patent Application Publication
(10) Pub. No.: US 2012/0137814 A1
(43) Pub. Date: Jun. 7, 2012

(54) EXTERNAL GEARSHIFT FOR A MANUAL-SHIFT TRANSMISSION

(75) Inventors: Sascha BRUDER, Mainz (DE); Frank LINDNER, Hattersheim (DE)

(73) Assignee: GM GLOBAL TECHNOLOGY OPERATIONS LLC, Detroit, MI (US)

(21) Appl. No.: 13/308,661

(22) Filed: Dec. 1, 2011

(30) Foreign Application Priority Data
Dec. 4, 2010 (DE) 10 2010 053 534.6

(51) Int. Cl. F16H 59/02

(52) U.S. Cl. 74/473.33

(57) ABSTRACT

An external gearshift is provided for a motor vehicle shift transmission comprises a shift selector lever that can be moved in a shift degree of freedom and a selection degree of freedom, a selector lever that can be pivoted about an axis, which is coupled to the shift selector lever in order to follow a movement of the shift selector lever in the selection degree of freedom, and a torsion spring, which acts on the selector lever, in order to load the shift selector lever into a neutral position of the selection degree of freedom.

### CROSS-REFERENCE TO RELATED APPLICATION

This application claims priority to German Patent Application No. 102010053534.6, filed Dec. 4, 2010, which is incorporated herein by reference in its entirety.

### TECHNICAL FIELD

The technical field relates to an external gearshift for a manual-shift transmission of a motor vehicle.

### BACKGROUND

An external gearshift conventionally comprises a shift selector lever, which is moveable in a holder in two degrees of freedom and whose position by way of control cables connected to the manual-shift transmission determines a gear engaged in said manual-shift transmission. With most external gearshifts, the shift selector lever is mounted in a ball joint, i.e., the two degrees of freedom are rotation degrees of freedom. A slotted link, through which the shift selector lever extends, restricts its movement possibilities to a movement along a selection gate and shifting gates branching off the latter, at the end of which in each case the shift positions of the shift selector lever corresponding to a gear of the transmission are located.

FIG. 1 shows a perspective view of such a conventional external gearshift. The ball joint, in which the shift selector lever 1 is rotatably mounted, is concealed in the interior of the holder 2, exactly like the slotted link that guides the shift selector lever 1. Interrupted lines at the tip of the shift selector lever 1 illustrate the course of the selection gate 35 and the shifting gates 36. From a ball that is received in the interior of the holder 2 and connected to the shift selector lever 1 in a fixed manner a finger 3 stands away radially, whose tip engages in an approximately L-shaped selector lever 5 that can be pivoted about an axis 4 running in vehicle transverse direction.

By moving up and down about an axis running in vehicle longitudinal direction upon a rotation of the shift selector lever 1, the tip of the finger 3 drives a rotation of the selector lever 5 about the axis 4 that is orthogonal thereto. An arm of the selector lever 5 running downwards from the axis 4 is connected at its free end to the core of a control cable (leading to the shift transmission that is not shown). In order to ensure that the shift selector lever 1 with no gear engaged always assumes a neutral position in the middle of the shifting gate 35, a coil spring 6 is arranged roundabout the axis 4, which has two arms 7, 8 standing away radially.

When, as is shown in FIG. 1, the shift selector lever 1 is deflected from the neutral position to the left and the finger 3 is lowered with respect to the neutral position accordingly, the finger 3 deflects the lower arm 8 downwards, while the upper arm 7 is blocked on a protrusion 9 of the holder 2. The tension of the coil spring 6 resulting from this drives the shift selector lever 1 in direction of its neutral position until the arm 8 in turn strikes the bottom of the protrusion 9. If the width of the finger 3 in vertical direction is not exactly matched to the dimensions of the protrusion line and the course of the arms 7, 8 the finger 3 can freely move between the arms 7, 8 a certain distance when these both bear against the protrusion 9, or the finger prevents one of the arms 7, 8 from coming in contact with the protrusion 9. I

In both cases, the shift selector lever is freely moveable a certain distance along the selection gate 35 and can be excited into trembling and rattling by driving vibrations. In order to avoid this, the coil spring 6, the finger 3 and the protrusion 9 have to be accurately matched to one another in shape and dimension and have close tolerances. In order to avoid the generation of noises during the striking of the arms 7, 8 against the finger 3 or the protrusion 9, the arms 7, 8 in each case are provided with an elastic covering of rubber. All this increases the costs of the external gearshift.

At least one object therefore is to state an external gearshift which with little expenditure makes possible noiseless shifting and defines a rest position of the shift selector lever free of play. In addition, other objects, desirable features, and characteristics will become apparent from the subsequent summary and detailed description, and the appended claims, taken in conjunction with the accompanying drawings and this background.

### SUMMARY

An external gearshift is provided for a motor vehicle shift transmission having a shift selector lever that can be moved in a shift degree of freedom and a selection degree of freedom, a selector lever that can be pivoted about an axis, which selector lever can be coupled to a shift selector lever in order to follow a movement of the shift selector lever in the selection degree of freedom, and a spring element, which loads the shift selection lever into a neutral position of the shift degree of freedom, the spring element being a torsion spring acting on the selector lever.

The torsion spring can run on the axis of the selector lever in a space-saving manner. If a first longitudinal end of the torsion spring at least in torsion direction acts on the selector lever free of play and a second longitudinal end acts on the holder of the external gearshift free of play at least in torsion direction, it can establish a neutral position of the shift selector lever free of play, so that any deflection of the shift selector lever from the neutral position is counteracted by a resetting force of the torsion spring. Such a zero-play action of the torsion spring on the selector lever or on the holder can be realized in that one of the longitudinal ends is positively received in a recess of the holder or of the selector lever. In order to realize such a positive connection, the torsion spring can comprise a facet that is extended at least in axial direction at its first and second longitudinal end.

Preferentially, the two facets are located in a same plane in the relaxed state of the torsion spring; then, the neutral position of the shift selector lever is unambiguously established even before the installation of the torsion spring as that position, in which surfaces of the recesses of holder and selector lever complementarily to the facets, are in alignment. In particular, the two facets can be part of a same surface of the torsion spring that is flat in the relaxed state. Such a torsion spring can for example be a rod with rectangular cross section. Alternatively, at least one of the longitudinal ends can also be received in a recess of the holder and/or the selector lever by way of a frictional connection. In this latter case, the torsion spring is practically cylindrical at least on this one longitudinal end and preferentially over its entire length. The torsion spring can be received in a protected manner in a hollow shaft.

In order to avoid or at least limit lurching of the rotary axis of the selector lever in space, a shaft, which is practically rigidly connected to the selector lever, which shaft can be the hollow shaft receiving the torsion spring or the torsion spring itself, is held on the holder via at least two bearings axially spaced along the shaft.

### BRIEF DESCRIPTION OF THE DRAWINGS

The present invention will hereinafter be described in conjunction with the following drawing figures, wherein like numerals denote like elements, and:

FIG. 1 already covered, a perspective view of a conventional external gearshift;

FIG. 2 a view of the holders of an external gearshift according to an embodiment;

FIG. 3 an axial section through a suspension of the selector lever according to a first embodiment;

FIG. 4 a section analog to FIG. 3 according to a second embodiment; and

FIG. 5 is a radial section through the suspension along the plane V-V of FIG. 4.

### DETAILED DESCRIPTION

The following detailed description is merely exemplary in nature and is not intended to limit application and uses. Furthermore, there is no intention to be bound by any theory presented in the preceding background or summary or the following detailed description.

Before the exemplary embodiments are discussed in detail, it is pointed out that it is in the nature of an example that not all of its features described in the following are mentioned in the following patent claims and that alternatives to some of these features not mentioned in the patent claims can exist, which are not separately described. The fact that two or more features are disclosed in a same sentence or in another type of context must therefore not be understood in the sense that these features are mutually conditional on one another; on the contrary, each of these features can also be combined with an equivalent of another feature, provided nothing to the contrary is said.

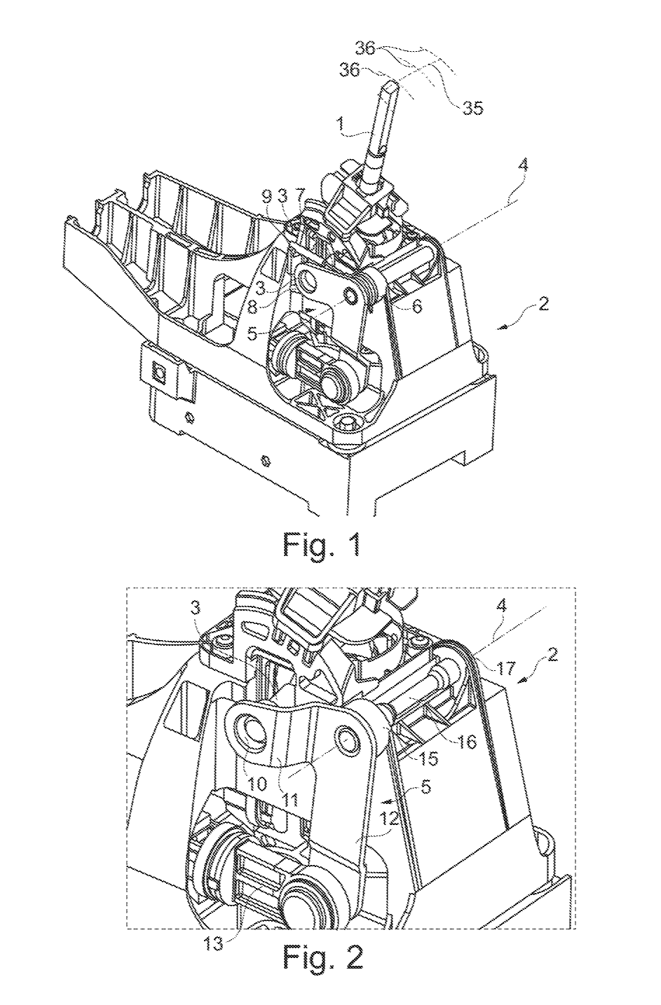

FIG. 2 merely shows a detail of a holder 2 of the external gearshift according to the invention at a scale that is enlarged compared with FIG. 1; the shift selector lever 1 mounted in this holder 2 via a ball joint corresponds to that shown in FIG. 1. Likewise, as in the case of FIG. 1, a finger 3 stands away from the ball of the shift selector lever concealed in the interior of the holder, the tip of which engages in a shaft 10 at the end of a substantially horizontal arm 11 of the substantially L-shaped selector lever 5 and from which a second arm 12 extending downwards from the axis 4 is coupled to a control cable 13 leading to the inner shift.

On a side facing away from the beholder in the perspective of FIG. 2, the selector lever 5 is provided with a hollow axle sleeve that rotatably engages and is concealed in an immediately adjacent bearing block 15 of the holder 2. A cylindrical torsion spring 16 fixed in the axle sleeve in a rotationally fixed manner extends along the rotary axis 4 of the selector lever 5 as far as to a second bearing block 17, where it is fixed to the holder 2 in a rotationally fixed manner.

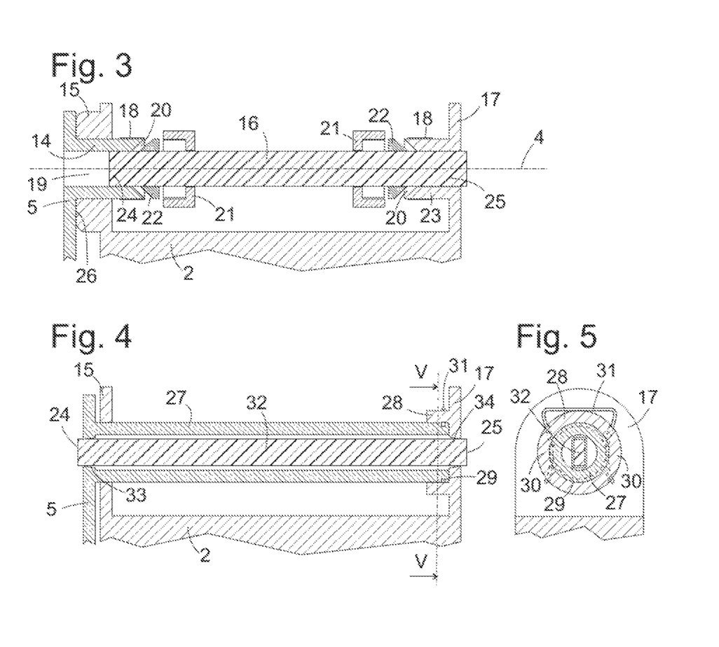

FIG. 3 shows a schematic section along the axis 4 through the selector lever 5, the torsion spring 16 and the bearing blocks 15, 17. The axle sleeve of the selector lever 5 designated 14 here is received in a bore of the bearing block 15 with just enough play so as not to hinder the rotation of the selector lever 5 about the axis 4. A distal end of the axle sleeve 14 is provided with an external thread 18. A bore 19 extending through the axle sleeve 14 has a conical flare 20 at the distal end. Between the axle sleeve 14 and a union nut 21 provided for screwing onto the external thread 18 a wedge ring 22 with cross section, in this case trapezium-shaped and complementarily to the flare 20 is pushed onto the torsion spring 16. When, while screwing the union nut 21 onto the external thread 18 the wedge ring 22 is subjected to pressure, it is, in contact with the walls of the flare 20, radially pushed to the inside so that it clamps a longitudinal end 24 of the torsion spring 16, frictionally connecting it with the selector lever 5 free of play in torsion direction.

A sleeve 23 of similar shape as the axle sleeve 14 is formed on the second bearing block 17, and a union nut 21 can be screwed onto the sleeve 23 in order to subject a wedge ring 22 to pressure, pressing it against the second longitudinal end 25 of the torsion spring 6. When during the tightening of the union nut 21 the tips of the wedge rings 22 engaging in the flares 20 of the axle sleeve 14 or the sleeve 23 cut into the torsion spring 16, they drive its longitudinal ends 24 and 25 apart or they generate a tensile stress in the middle part of the torsion spring 16, which holds the selector lever 5 pressed against an end face 26 of the bearing block 15 and in this manner contributes to the fixing of the rotary axis 4 of the selector lever 5 in space.

FIG. 4 shows a longitudinal section through the suspension of the selector lever 5 according to a second configuration, and FIG. 5 shows a cross section through the suspension along the plane designated V-V in FIG. 4. The axle sleeve of the selector lever 5 in this case is extended into a tubular cylindrical shaft which extends through a close-tolerance bore of the bearing block 15 facing the selector lever 5 and is rotatably received in a sleeve 28 of the bearing block 17 located opposite. The end of the hollow shaft 27 engaging in the sleeve 28 is provided with an external circumferential groove 29. The groove 29 serves to fix the shaft 27 in axial direction with the help of an inserted wire clip 31 engaging in the groove 29 through lateral slits (see FIG. 5) of the sleeve 28. A torsion spring 32 in the form of a square section is inserted with one of its longitudinal ends 24 into a rectangular opening 33 of the selector lever 5 and with its other longitudinal end 25 into a corresponding opening 34 in an end wall of the bearing block 17 in an accurately fitting manner. In order to facilitate sliding the torsion spring 32 into the openings when sliding the shaft 27 into the bearing blocks 15, 17, the openings 33, 34 can be conically flared to one side. The flanks 37 of the square section are flat in the relaxed state so that the neutral position, towards which the shift selector tents under the influence of the torsion spring 32, always is the position in which the edges of the openings 33, 34 are in alignment with each other.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An external gearshift for a motor vehicle shift transmission, comprising:
a shift selector lever that is configured to move in a shift degree of freedom and a selector degree of freedom;
a selector lever that is configured to pivot about an axis and coupled to the shift selector lever in order to follow a movement of the shift selector lever in the selector degree of freedom; and
a torsion spring configured to act on the selector lever and further configured to load the shift selector lever into a neutral position of the selector degree of freedom.

2. The external gearshift according to claim 1, wherein the torsion spring extends on the axis.

3. The external gearshift according to claim 1, wherein the torsion spring comprises:
a first longitudinal end; and
a second longitudinal end,
wherein the first longitudinal end in at least a torsion direction acts free of play on the selector lever, and
wherein the second longitudinal end in at least the torsion direction acts free of play on a holder of the external gearshift.

4. The external gearshift according to claim 3, wherein the first longitudinal end of the torsion spring is positively received in a recess of the holder or of the selector lever.

5. The external gearshift according to claim 3, wherein the second longitudinal end of the torsion spring is positively received in a recess of the selector lever.

6. The external gearshift according to claim 3,
wherein the torsion spring at the first longitudinal end comprises a first facet expanded in an axial direction,
wherein the second longitudinal end comprises a second facet expanded in the axial direction, and
wherein the first facet and the second facet in a relaxed state of the torsion spring lie in a substantially similar plane.

7. The external gearshift according to claim 6, wherein the first facet and the second facet are part of a surface of the torsion spring that is flat in the relaxed state.

8. The external gearshift according to claim 3, wherein the second longitudinal end is received in a recess of the holder in a frictionally connected manner.

9. The external gearshift according to claim 3, wherein the first longitudinal end is received in a recess of the selector lever in a frictionally connected manner.

10. The external gearshift according to claim 3, wherein the torsion spring is cylindrical at least on the first longitudinal end.

11. The external gearshift according to claim 3, wherein the torsion spring is cylindrical at least on the second longitudinal end.

12. The external gearshift according to claim 3, wherein the torsion spring is received in a hollow shaft.

13. The external gearshift according to claim 12, wherein the hollow shaft is rigidly connected to the selector lever and held on the holder with at least two bearings axially spaced from each other.
